(19) United States
(12) Patent Application Publication
(10) Pub. No.: US 2024/0292315 A1
(43) Pub. Date: Aug. 29, 2024

(54) SYSTEM AND METHOD TO AUTOMATICALLY ENABLE AND DISABLE A SIGNAL TRANSMITTER

(71) Applicant: Dell Products L.P., Round Rock, TX (US)

(72) Inventor: Jeffrey Ian Goldberg, Ra'anana (IL)

(21) Appl. No.: 18/176,194

(22) Filed: Feb. 28, 2023

(51) Int. Cl. H04W 48/04; H04W 64/00; H04W 76/30

(52) U.S. Cl. CPC H04W 48/04; H04W 64/003; H04W 76/30

(57) ABSTRACT

A method for automatically disabling and enabling a signal transmitter in a mobile device includes monitoring, by a signal transmission manager, a location of the mobile device. The method further includes making a first determination, using the signal transmission manager, that the location is indicative of an airport. Also, the method includes enabling, in response to the first determination, an airplane detection module. Moreover, the method includes making a second determination, using the airplane detection module, that the mobile device is located on an airplane. In addition, the method includes disabling, in response to the second determination, the signal transmitter. Further, the method includes making a third determination, using the airplane detection module, that operation of the signal transmitter is compatible with operation of the airplane. The method also includes enabling, in response to the third determination, the signal transmitter.

### BACKGROUND

Users may bring mobile devices onto airplanes with them as part of their travel. Further, security systems installed on the mobile devices may utilize signal transmissions that are required to be turned off during certain times of the airplane operations by rule or regulation.

### SUMMARY

In general, embodiments described herein relate to a method for automatically disabling and enabling a signal transmitter in a mobile device. The method includes monitoring, by a signal transmission manager, a location of the mobile device. The method further includes making a first determination, using the signal transmission manager, that the location is indicative of an airport. Also, the method includes enabling, in response to the first determination, an airplane detection module. Moreover, the method includes making a second determination, using the airplane detection module, that the mobile device is located on an airplane. In addition, the method includes disabling, in response to the second determination, the signal transmitter. Further, the method includes making a third determination, using the airplane detection module, that operation of the signal transmitter is compatible with operation of the airplane. The method also includes enabling, in response to the third determination, the signal transmitter.

In general, embodiments described herein relate to a method for automatically disabling and enabling a signal transmitter in a mobile device. The method includes making a first determination that the mobile device is located on an airplane based on first data from at least one of a sound sensor, a vibration sensor, and an accelerometer. The method also includes disabling, in response to the first determination, signal transmission of the signal transmitter. Further, the method includes making a second determination. After the disabling, that operation of the signal transmitter is compatible with operation of the airplane based on second data from any combination of the sound sensor, the vibration sensor, the accelerometer, a location sensor, and one of multiple detected wireless network access point names. In addition, the method includes enabling, in response to the second determination, signal transmission of the signal transmitter.

In general, embodiments described herein relate to a non-transitory computer readable medium including computer readable program code, which when executed by a computer processor enables the computer processor to perform a method for automatically disabling and enabling a signal transmitter of a mobile device, the method including monitoring, by a signal transmission manager, a location of the mobile device based on first data received by at least one of a sound sensor, a vibration sensor, an accelerometer, a location sensor, one of a plurality of detected wireless network access point names, and the signal transmitter. The method also includes making a first determination, using the signal transmission manager and based on the first data, that the location is indicative of an airport. Further, the method includes enabling, in response to the first determination, an airplane detection module. In addition, the method includes making a second determination, using the airplane detection module, that the mobile device is located on an airplane, based on second data from at least one of the sound sensor, the vibration sensor, and the accelerometer. Moreover, the method includes disabling, in response to the second determination, the signal transmitter. Also, the method includes making a third determination, using the airplane detection module, that operation of the signal transmitter is compatible with operation of the airplane, based on third data from any combination of the sound sensor, the vibration sensor, the accelerometer, the location sensor, and another one of the plurality of detected wireless network access point names. The method further includes enabling, in response to the third determination, the signal transmitter.

Other aspects of the embodiments disclosed herein will be apparent from the following description and the appended claims.

### BRIEF DESCRIPTION OF DRAWINGS

Certain embodiments of the invention will be described with reference to the accompanying drawings. However, the accompanying drawings illustrate only certain aspects or implementations of the invention by way of example and are not meant to limit the scope of the claims.

FIG. 1 shows a diagram of a system in accordance with one or more embodiments of the invention.

FIG. 2 shows a flowchart of a method for automatically disabling and enabling a signal transmitter accordance with one or more embodiments of the invention.

FIG. 3 shows a computing system in accordance with one or more embodiments of the invention.

### DETAILED DESCRIPTION

In the below description, numerous details are set forth as examples of embodiments described herein. It will be understood by those skilled in the art, and having the benefit of this Detailed Description, that one or more embodiments of embodiments described herein may be practiced without these specific details and that numerous variations or modifications may be possible without departing from the scope of the embodiments described herein. Certain details known to those of ordinary skill in the art may be omitted to avoid obscuring the description.

In the below description of the figures, any component described with regard to a figure, in various embodiments described herein, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments described herein, any description of the components of a figure is to be interpreted as an optional embodiment, which may be implemented in addition to, in conjunction with, or in place of the embodiments described with regard to a corresponding like-named component in any other figure.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

As used herein, the phrase operatively connected, or operative connection, means that there exists between elements/components/devices a direct or indirect connection that allows the elements to interact with one another in some way. For example, the phrase ‘operatively connected’ may refer to any direct (e.g., wired directly between two devices or components) or indirect (e.g., wired and/or wireless connections between any number of devices or components connecting the operatively connected devices) connection. Thus, any path through which information may travel may be considered an operative connection.

The following describes one or more embodiments.

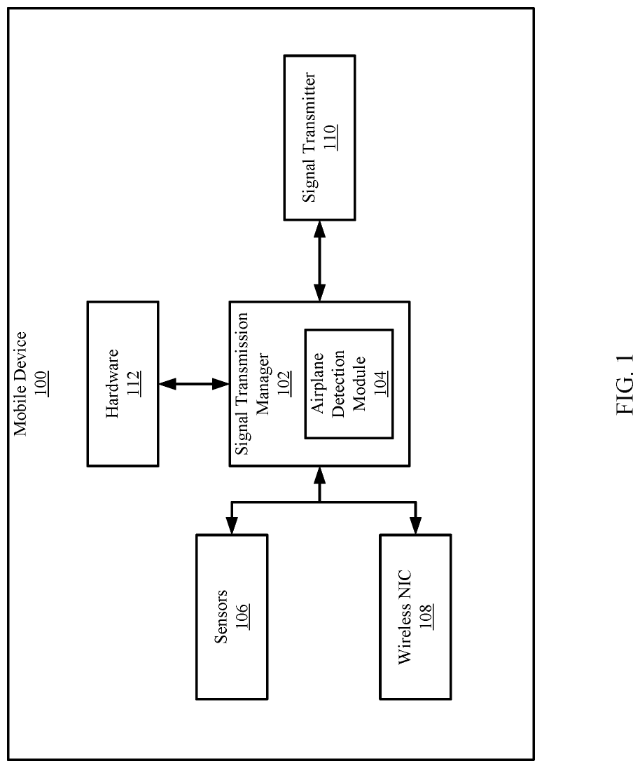

FIG. 1 shows an example mobile device (100) in accordance with one or more embodiments of the invention. The mobile device (100) includes a signal transmission manager (102), sensors (106), a wireless network interface card (NIC) (108), a signal transmitter (110), and hardware (112). The system may include additional, fewer, and/or different components without departing from the invention. Each component may be operably connected to any of the other components via any combination of wired and/or wireless connections. Each component illustrated in FIG. 1 is discussed below.

In one or more embodiments of the invention, the mobile device (100) may represent any physical device or computing system designed and configured to receive, generate, process, store, and/or transmit digital data. The mobile device (100) may be, for example, a mobile phone, a tablet computer, a laptop computer, or any other mobile computing device that a user may carry on an airplane.

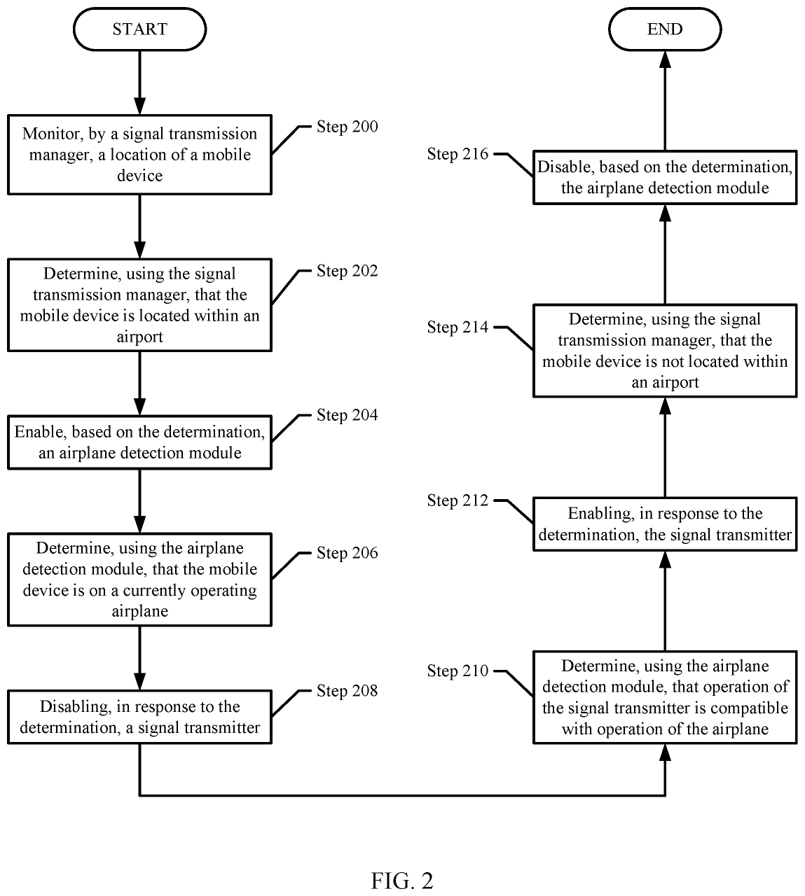

In one or more embodiments of the invention, the signal transmission manager (102) is implemented as a computing device (see e.g., FIG. 5). The computing device may include one or more processors, memory (e.g., random access memory), and persistent storage (e.g., disk drives, solid state drives, etc.). The computing device may include instructions, stored on the persistent storage, that when executed by the processor(s) of the computing device cause the computing device to perform the functionality of the signal transmission manager (102) described throughout this application and/or all, or a portion thereof, of the method illustrated in FIG. 2.

In one or more embodiments of the invention, the signal transmission manager (102) is implemented as a logical device. The logical device may utilize the computing resources of the mobile device (100) (e.g., via the hardware (112)) and thereby provide the functionality of the signal transmission manager (102) described throughout this application and/or all, or a portion thereof, of the method illustrated in FIG. 2.

In one or more embodiments of the invention, the signal transmission manager (102) also includes an airplane detection module (104) which includes functionality to detect certain aspects related to air travel as discussed in detail below.

In one or more embodiments of the invention, the sensors (106) include any number of sensors and any number of each type of sensor described herein. The sensors (106) may include a location sensor that provides global positions (i.e., latitude and longitude coordinates) using any of the global navigation satellite systems in use, including GPS, BeiDou, Galileo, GLONASS, IRNSS, and QZSS. The sensors (106) may include a sound sensor that collects and provides sound data such as a microphone. The sensors (106) may include an accelerometer that provides acceleration data and is operable to detect acceleration along any number of axes, including one axis, two axes, three axes, or more axes. The sensors (106) may include a vibration sensor that provides vibration data and includes the accelerometer, a displacement sensor, and/or a velocity sensor.

In one or more embodiments of the invention, the wireless NIC (108) is operable to wirelessly connect to networks and/or devices and obtain and provide, among other things, wireless access point names associated with the networks and/or device names associated with the devices. The networks may be, for example, a network that includes one or more wireless links such as an IEEE 802.11 compliant link. Further, the connection to devices may be established using wireless protocols such as Bluetooth.

In one or more embodiments of the invention, the signal transmitter (110) is a transmitter operable to send and receive wireless signals. In one or more embodiments, the wireless signals are cellular signals that may include signals used in conjunction with third generation (3G) technology, long-term evolution (LTE) technology, fifth generation (5G) technology, or any other technology used for cellular signals. Further, the signal transmitter may be operable to identify a nearest cellular site which may provide additional information, such as an area of latitudes and longitudes, a mobile country code, mobile network code, location area code, and/or a cell ID.

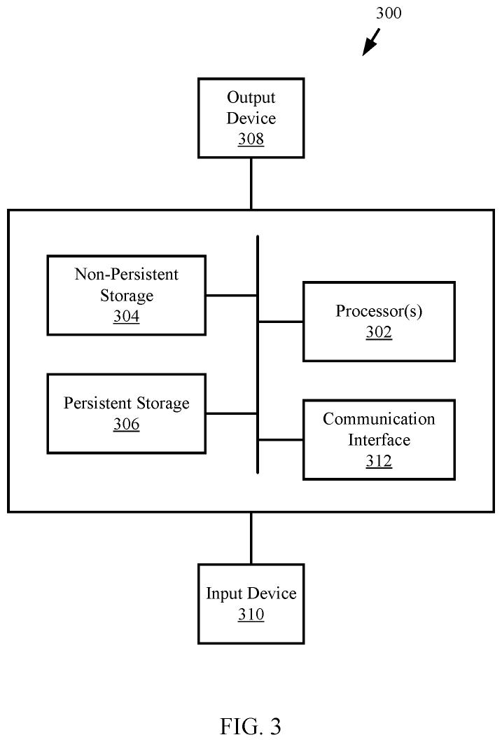

In one or more embodiment, the hardware (112) includes any combination of elements of a computing device as described in further detail below with respect to FIG. 3. The hardware (112) may provide resources to the signal transmission manager (102) to enable the signal transmission manager (102) to perform one or more of the steps described below with reference to FIG. 2.

Automatically enabling and disabling a signal transmitter:

Mobile devices may utilize security systems that rely on tracking via cellular signals. However, air travel often requires that cellular signal be turned off during certain operations of an airplane. For example, many jurisdictions and/or airline operators require passengers to disable signal transmitters, and particularly cellular signal transmitters, while the airplane is taking-off, flying, and landing. In previous implementations of providing security solutions using the cellular signals, a user would be responsible for manually disabling the cellular signal transmitter before taking-off and enabling the cellular signal transmitter after landing. However, many users may forget to enable the cellular signal transmitter after landing, thereby presenting a security risk. The method described in FIG. 2 may significantly reduce the security risk by automatically disabling the cellular signal transmitter before take-off and automatically enabling the cellular signal transmitter after landing.

Turning to FIG. 2, FIG. 2 shows a flowchart describing a method for automatically disabling and enabling a signal transmitter in accordance with one or more embodiments disclosed herein. The method may be performed by, for example, the signal transmission manager (102, FIG. 1).

While the various steps in the flowchart shown in FIG. 2 are presented and described sequentially, one of ordinary skill in the relevant art, having the benefit of this Detailed Description, will appreciate that some or all of the steps may be executed in different orders, that some or all of the steps may be combined or omitted, and/or that some or all of the steps may be executed in parallel.

In step 200, the signal transmission manager (102, FIG. 1) monitors a location of a mobile device. In one embodiment, the signal transmission manager monitors the latitude and longitude of the mobile device. The monitoring may be performed in real-time or near real-time, or at any suitable interval, including every 30 seconds, 1 minute, 5 minutes, 10 minutes, 15 minutes, 20 minutes, 30 minutes, 45 minutes or any amount of time between 30 seconds and 45 minutes. To do so, the signal transmission manager may utilize data received from a location sensor, as described above, to receive data indicative of latitude and longitude. Further, the signal transmission manager may use an accelerometer in connection with the location sensor to determine the location of the mobile device. For example, the location sensor may provide latitude and longitude data at set intervals. Then, the data from the accelerometer may be used by the signal transmission manager to determine the change in latitude and longitude from the previously received latitude and longitude data received from the location sensor. In this manner, the signal transmission manager may monitor the location of the mobile device between intervals of receiving data from the location sensor.

Further, in one embodiment, the signal transmission manager may utilize a wireless NIC (e.g., 108, FIG. 1) to monitor the location of the mobile device. For example, the wireless NIC may provide information such as detected wireless access point names. The signal transmission manager may then compare the detected wireless access point names with a database containing wireless access point names and their associated latitudes and longitudes.

Further, in one embodiment, the signal transmission manager may utilize a signal transmitter (e.g., 110, FIG. 1) to monitor the location of the mobile device. For example, the signal transmitter may be a cellular signal transmitter that provides information such as an area of latitudes and longitudes, a mobile country code, mobile network code, location area code, and/or a cell ID associated with a nearest cellular site. One or more of the pieces of information provided by the cellular signal transmitter may be compared with a database containing the information and the associated latitudes and longitudes.

In step 202, the signal transmission manager determines that the mobile device is located within an airport. In step 200, the signal transmission manager monitors the latitude and longitude of the mobile device. Then, the signal transmission manager compares the latitude and longitude of the mobile device with a database of latitudes and longitudes associated with airports. If the signal transmission manager determines that the latitude and longitude of the mobile device is within the range of one of the latitudes and longitudes of an airport, then the signal transmission manager determines that the mobile device is located within an airport.

In one embodiment, the mobile device may be located in an airport, but the latitudes and longitudes associated with the airport are not in the database used by the signal transmission manager. In such an embodiment, the signal transmission manager may utilize other data to determine that the mobile device is located within an airport. For example, aircraft typically have two different boarding procedures-walking across an air bridge from a terminal to an airplane, or walking from a terminal and up an airport ramp and into an airplane. The signal transmission manager may receive data from any combination of a sound sensor, a vibration sensor, and the accelerometer to detect these different boarding procedures, and, based on detecting a boarding procedure, determine that the mobile device is located within an airport.

In step 204, the signal transmission manager enables an airplane detection module based on determining that the mobile device is located within an airport. The airplane detection module may consume additional resources. As such, in the interest of reducing the consumption of resources (e.g., computing and/or energy resources), the airplane detection module is in a disabled state during normal operation.

In step 206, the airplane detection module determines that the mobile device is located on a currently operating airplane. In one embodiment, the airplane detection module utilizes data from the vibration sensor and/or the sound sensor to determine that the engines of the airplane are running. In one embodiment, the airplane detection module utilizes data from the location sensor and/or the accelerometer to determine that the airplane has been towed away from the gate. In one embodiment, the airplane detection module utilizes data received from any combination of the sensors to determine that the mobile device is moving above a threshold speed typically achieved only by airplanes. The threshold speed may be 100, 120, 150, 175, 200, or more miles per hour. In one embodiment, the airplane detection module utilizes data received from any combination of sensors to determine that the mobile device is above a threshold altitude only achievable via flight. The threshold altitude may be based on altitudes of the highest cities in the world and may be, for example, 3900, 4000, 4100, or more meters above sea level. Further, the airplane detection module determining that the mobile device is located on the currently operating airplane may be based on any combination of the above-described embodiments.

In step 208, the signal transmitter is disabled in response to determining that the mobile device is on the currently operating airplane.

In step 210, the airplane detection module determines that operation of the signal transmitter is compatible with operation of the airplane. While the airplane is travelling from one location to another, the signal transmitter remains in a disabled state. However, after the plane has landed, it may be useful to enable the signal transmitter.

In determining that operation of the signal transmitter is compatible with operation of the airplane, the airplane detection module monitors the operation of the airplane in real time or near real-time, or at any suitable interval, including every 30 seconds, 1 minute, 5 minutes, 10 minutes, 15 minutes, 20 minutes, 30 minutes, 45 minutes or any amount of time between 30 seconds and 45 minutes. Further, in one embodiment, the airplane detection module utilizes data received from any combination of the sensors to determine that the mobile device is moving below a combination of a threshold speed typically incompatible with flight of an airplane and a threshold altitude. The threshold speed may be 100, 75, 50, 25, 10, 5, or fewer miles per hour. The threshold altitude may be based on altitudes of the highest cities in the world and may be, for example, 4500, 4250, 4000, or fewer meters above sea level. In one embodiment, the airplane detection module may utilize data from the vibration sensor and/or the sound sensor to determine that the engines are not running. In one embodiment, the airplane detection module may utilize data from the accelerometer to determine that a user holding the mobile device is walking. In one embodiment, the airplane detection module utilizes data from the wireless NIC to determine that a wireless access point associated with an airport is nearby, as described above. In another embodiment, the airplane detection module utilizes data from the location sensor to determine that the mobile device is located within an area associated with an airport, as described above. Further, the airplane detection module determining that the operation of the signal transmitter is compatible with operation of the airplane may be based on any combination of the above-described embodiments.

In step 212, the signal transmitter is enabled in response to determining that operation of the signal transmitter is compatible with operation of the airplane.

In step 214, the signal transmission manager determines that the mobile device is not located within an airport. After a user has exited the airplane, the user may still be within an airport. The airplane detection module may remain enabled as users may exit one airplane and board another airplane without leaving the airport. As such, the functionality provided by the airplane detection module may still be worth the additional resources consumed by the airplane detection module. Further, the signal transmission manager may utilize any combination of the embodiments described in reference to step 202 to determine that the mobile device is not located in an airport.

In step 216, the signal transmission manager disabled the airplane detection module based on determining that the mobile device is not located in an airport. As described above, the airplane detection module may consume certain resources. Thus, disabling the airplane detection module may preserve those certain resources.

The method may end following step 216.

As discussed above, embodiments of the invention may be implemented using computing devices. FIG. 3 shows a diagram of a computing device (300) in accordance with one or more embodiments of the invention. The computing device (300) may include one or more computer processors (302), non-persistent storage (304) (e.g., volatile memory, such as random access memory (RAM), cache memory), persistent storage (306) (e.g., a hard disk, an optical drive such as a compact disk (CD) drive or digital versatile disk (DVD) drive, a flash memory, etc.), a communication interface (312) (e.g., Bluetooth interface, infrared interface, network interface, optical interface, etc.), input devices (310), output devices (308), and numerous other elements (not shown) and functionalities. Each of these components is described below.

In one embodiment of the invention, the computer processor(s) (302) may be an integrated circuit for processing instructions. For example, the computer processor(s) (302) may be one or more cores or micro-cores of a processor. The computing device (300) may also include one or more input devices (310), such as a touchscreen, keyboard, mouse, microphone, touchpad, electronic pen, or any other type of input device. The communication interface (312) may include an integrated circuit for connecting the computing device (300) to a network (not shown) (e.g., a local area network (LAN), a wide area network (WAN) such as the Internet, mobile network, or any other type of network) and/or to another device, such as another computing device.

In one embodiment of the invention, the computing device (300) may include one or more output devices (308), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) (308, 310) may be locally or remotely connected to the computer processor(s) (302), non-persistent storage (304), and persistent storage (306). Many diverse types of computing devices exist, and the aforementioned input and output device(s) (308, 310) may take other forms.

The problems discussed above should be understood as being examples of problems solved by embodiments of the invention and the invention should not be limited to solving the same/similar problems. The disclosed invention is broadly applicable to address a range of problems beyond those discussed herein.

While embodiments described herein have been described with respect to a limited number of embodiments, those skilled in the art, having the benefit of this Detailed Description, will appreciate that other embodiments can be devised which do not depart from the scope of embodiments as disclosed herein. Accordingly, the scope of embodiments described herein should be limited only by the attached claims.

What is claimed is:

1. A method for automatically disabling and enabling a signal transmitter in a mobile device, the method comprising:
monitoring, by a signal transmission manager, a location of the mobile device;
making a first determination, using the signal transmission manager, that the location is indicative of an airport;
enabling, in response to the first determination, an airplane detection module;
making a second determination, using the airplane detection module, that the mobile device is located on an airplane;
disabling, in response to the second determination, the signal transmitter;
making a third determination, using the airplane detection module, that operation of the signal transmitter is compatible with operation of the airplane; and
enabling, in response to the third determination, the signal transmitter.

2. The method of claim 1, further comprising:
making a fourth determination, after enabling the signal transmitter, that the mobile device is no longer located in a second location indicative of a second airport; and
disabling, in response to the fourth determination, the airplane detection module.

3. The method of claim 1, wherein the third determination is made based on periodically checking, at a time interval, the operation of the airplane.

4. The method of claim 3, wherein the time interval is between ten minutes and thirty minutes.

5. The method of claim 1, wherein the signal transmitter is a cellular signal transmitter.

6. The method of claim 1, wherein the second determination comprises determining that the airplane is moving.

7. The method of claim 1, wherein the third determination comprises determining that an engine of the airplane is no longer running.

8. The method of claim 7, wherein determining that the engine of the airplane is no longer running is made using one of a vibration sensor and a sound sensor.

9. The method of claim 1, wherein the third determination comprises determining that the mobile device is not located on the airplane.

10. The method of claim 1, wherein the mobile device is a laptop.

11. A method for automatically disabling and enabling a signal transmitter in a mobile device, the method comprising:
making a first determination that the mobile device is located on an airplane based on first data from at least one of a sound sensor, a vibration sensor, and an accelerometer;
disabling, in response to the first determination, signal transmission of the signal transmitter;
making a second determination, after the disabling, that operation of the signal transmitter is compatible with operation of the airplane based on second data from any combination of the sound sensor, the vibration sensor, the accelerometer, a location sensor, and one of a plurality of detected wireless network access point names; and
enabling, in response to the second determination, signal transmission of the signal transmitter.

12. The method of claim 11, further comprising:
monitoring a location of the mobile device using any combination of the sound sensor, the vibration sensor, the accelerometer, the location sensor, another one of the plurality of detected wireless network access point names, and the signal transmitter;
making a third determination that the location is indicative of an airport; and
enabling, in response to the third determination, an airplane detection module, and wherein the first determination is made using the airplane detection module.

13. The method of claim 12, wherein the location is further indicative of an air bridge or an airport ramp.

14. The method of claim 11, wherein the signal transmitter is a cellular signal transmitter.

15. The method of claim 11, wherein the first determination comprises determining that the first data is indicative of the airplane moving.

16. The method of claim 15, wherein the second determination comprises determining that the second data is indicative of an engine of the airplane no longer running.

17. The method of claim 16, wherein determining that the second data is indicative of the engine of the airplane no longer running is made using one of the vibration sensor and the sound sensor.

18. The method of claim 15, wherein the second determination comprises determining that the second data is indicative of the mobile device not being located on the airplane.

19. The method of claim 11, wherein disabling signal transmission of the signal transmitter does not affect any other operation of the mobile device.

20. A non-transitory computer readable medium comprising computer readable program code, which when executed by a computer processor enables the computer processor to perform a method for automatically disabling and enabling a signal transmitter of a mobile device, the method comprising:
monitoring, by a signal transmission manager, a location of the mobile device based on first data received by at least one of a sound sensor, a vibration sensor, an accelerometer, a location sensor, one of a plurality of detected wireless network access point names, and the signal transmitter;
making a first determination, using the signal transmission manager and based on the first data, that the location is indicative of an airport;
enabling, in response to the first determination, an airplane detection module;
making a second determination, using the airplane detection module, that the mobile device is located on an airplane, based on second data from at least one of the sound sensor, the vibration sensor, and the accelerometer;
disabling, in response to the second determination, the signal transmitter;
making a third determination, using the airplane detection module, that operation of the signal transmitter is compatible with operation of the airplane, based on third data from any combination of the sound sensor, the vibration sensor, the accelerometer, the location sensor, and another one of the plurality of detected wireless network access point names; and
enabling, in response to the third determination, the signal transmitter.
